(19) United States
(12) Patent Application Publication
(10) Pub. No.: US 2015/0311763 A1
(43) Pub. Date: Oct. 29, 2015

(54) TWO-COMPONENT ISOLATION OF BL STATORS

(71) Applicant: Hilti Aktiengesellschaft, Schaan (LI)

(72) Inventors: Peter Hufnagel, Pforzen (DE); Thomas Schaefer, Obermeitingen (DE)

(21) Appl. No.: 14/743,646

(22) Filed: Jun. 18, 2015

Related U.S. Application Data
(63) Continuation of application No. PCT/EP2013/076844, filed on Dec. 17, 2013.

(30) Foreign Application Priority Data
Dec. 20, 2012 (DE) 10 2012 223 973.1

(51) Int. Cl. H02K 3/38; H02K 3/34; H02K 3/30

(52) U.S. Cl. CPC H02K 3/38; H02K 3/30; H02K 3/345

(57) ABSTRACT

Stator for an electrodynamic machine, in particular an electric motor, said stator comprising a stator assembly having a first end face and a second end face, wherein a thermally conductive web insulation is provided on the inside of the stator assembly; and a winding support device is provided on at least one end face of the stator assembly.

### RELATED APPLICATIONS

This application claims priority to, and is a continuation of, PCT Application No. PCT/EP2013/076844 having an International filing date of Dec. 17, 2013, which is incorporated herein by reference, and which claims priority to German Patent Application No. 10 2012 223 973.1, having a filing date of Dec. 20, 2012, which is also incorporated herein by reference in its entirety.

### SUMMARY OF THE TECHNOLOGY

The invention relates to a stator for an electrodynamic machine, in particular an electric motor. In this case the stator comprises a stator assembly having a first end face and a second end face.

### BACKGROUND OF THE INVENTION

Usually a stator or more specifically a stationary part for an electric motor consists, among other things, of a stator assembly. For this purpose the stator assembly is formed by individual sheet metal rings. In addition, the stator assembly has a number of stator poles (or webs) that extend radially into the interior of the stator assembly. Between the individual stator poles there are intermediate spaces in the form of pole slots or more specifically winding slots. The stator poles are used to receive the stator coils.

Usually the inner surface of the stator assembly, the stator poles (webs), and the pole slots are encapsulated by injection molding or sheathed with a synthetic plastic material. As an alternative, the pole slots can also be insulated with paper. The synthetic plastic material can be, for example, polymers, such as, for example, a thermosetting or thermoplastic material. In this case the plastic encapsulation forms the actual winding supports, which are used to receive the stator coils, around the individual stator poles.

Such a stator is known from the EP patent 2 015 426. This document on the prior art discloses a stator for a drive device of a hand tool, such as, for example, a cordless screwdriver. In this case the stator comprises two axial stator ends, on each of which a connecting element, for example, a bearing plate or a lid, is disposed. Moreover, the stator has in its interior a plurality of radially inwardly extending webs that extend over the entire length of the stator and that are separated by winding slots. A stator winding or rather a stator coil is attached around the webs. Between the webs and the stator winding a slot insulation is provided.

Due to the high wire tension, which is necessary for winding the stator coils, it is possible to deform the winding supports on the ends of the stator assembly. Moreover, it can also result in the winding supports breaking off as a consequence of this high wire tension.

In order to meet the high requirements of the winding process, in particular, the requirements of the high wire tension, only thermoplastic materials with a high modulus of elasticity (Young's modulus), i.e., high strength plastic often with a high glass fiber content, are used at the present time to manufacture the winding supports. However, if thermoplastic materials are used, then the high tension on the wire of the winding can result in a relatively severe deformation of the winding supports. Although plastics that have a higher fill content exhibit a higher rigidity for the use of the winding supports, eventually these materials will also cause the winding supports to break under the load of the high tension on the wire.

In addition and beyond the above drawback, the thermal conductivity of the materials that are typically used for the winding supports presents a problem. The heat that is generated in the stator coils (electrical losses, induction, etc.) has to be conducted, for example, over the winding supports to the outer surface of the stator assembly, in order to counteract an overheating inside the stator assembly. At the same time synthetic plastic materials that have an optimized thermal conductivity frequently do not meet the requirements of the winding process, because they are also deformed by or even break under the high levels of wire tension that are required for the winding operation. However, the thermoplastic materials, which are more or less only available and which have an optimized thermal conductivity, have limitations in terms of the length of the path of flow and the minimum wall thickness that depends on (or is required for) this flow path length. In order to counteract these limitations, walls of greater thickness are often introduced into the winding supports. However, these walls of greater thickness in turn result in a poor dissipation of the heat from the stator coils over the thermoplastic material to the stator assembly.

### SUMMARY OF THE INVENTION

One object of the present invention is to solve the aforementioned problems and to provide for this purpose a stator that meets the requirements of the winding process, in particular, the high wire tension and that simultaneously ensures better dissipation of the heat out of the stator.

This engineering object is achieved according to the invention by means of a stator for an electrodynamic machine, in particular an electric motor. In this case the stator comprises a stator assembly having a first end face and a second end face.

According to the invention, a thermally conductive web insulation is provided on the inside of the stator assembly; and a winding support device is provided on at least one end face of the stator assembly. The thermally conductive web insulation is attached to the inside of the stator assembly and, in so doing, forms, in each case a receiving element at each web of the stator assembly, in order to receive a winding. The attachment can be implemented in the form of an injection process.

Moreover, an additional winding support device can also be provided on the second end face of the stator assembly.

According to one advantageous embodiment of the present invention, the winding support device may be designed as an annular part. This annular design of the winding support device allows said winding support device to be positioned on the respective end faces of the stator assembly in such a way that it fits or more specifically forms a positive fit.

Furthermore, it is also possible for the annular part to comprise at least two components. In this case the at least two components of the annular part may be connected to each other on at least one of the end faces of the stator assembly in a separate manufacturing step prior to positioning.

In order to be able to position even more additional add on parts, such as, for example, a receiving device for a rotor or a transmission mounting, on the stator, at least one receiving device for receiving an add-on part may be included on the winding support device.

According to another advantageous embodiment of the present invention, the receiving device may be implemented by means of a lowered function surface.

As an alternative, however, the receiving device can be implemented by means of a raised function surface.

Both the lowered and the raised function surface are used in each case as an essential part for a plug in or clip connection with a corresponding counterpart on the respective add-on part that is to be connected.

According to another advantageous embodiment of the present invention, a connecting device may be provided between the thermally conductive web insulation and the winding support device. The connecting device is used to connect temporarily or permanently the thermally conductive web insulation and the winding support device to each other.

In this case the connecting device may comprise a first connecting element, which is positioned on the thermally conductive web insulation, and a second connecting element, which is positioned on the winding support device. For this purpose the first connecting element is positioned on at least one end face of the stator assembly. The second connecting element is positioned on a contact surface of the winding support device, with which the winding support device is directed towards the at least one end face of the stator assembly. The connecting device may be implemented as a frictional or positive connection or by material bonding.

According to one advantageous embodiment of the present invention, the connecting device may be implemented in the form of a plug-in connection, screw connection or tongue and groove connection. In the case of a plug-in connection, a hole or bore may be provided on the end faces of the stator assembly. The winding support device in turn may be provided with a number of pins that correspond to the holes or more specifically the bores. In order to connect the thermally conductive web insulation and the winding support device, the pins are inserted into the holes or more specifically the bores and are held by the latter.

In order for the winding support device to generate sufficient resistance against the forces generated by the winding, in particular against the wire tension, the winding support device may comprise at least one higher strength material. In this case the material that is to be used for the winding support device can exhibit an especially high mechanical strength.

Moreover, the higher strength material of the winding support device may be implemented by means of a synthetic plastic material. In this case the plastic material that is used for this purpose can exhibit an especially high mechanical strength.

In addition, the thermally conductive web insulation may be implemented by means of a synthetic plastic material. In this case the plastic material that is to be used may exhibit extremely good thermally conductive properties.

It is possible that the thermally conductive web insulation and the winding support device are made of any other suitable material. For this purpose a first plastic material may be selected for the thermally conductive web insulation, where in this case the first plastic material has very good heat dissipating properties. The second plastic material for the winding support device may have a high mechanical strength.

In order to attach the thermally conductive web insulation to the stator assembly, the stator can be encapsulated or molded with the material of the thermally conductive web insulation. However, it is also possible to use any other suitable method for attaching the thermally conductive web insulation to the stator assembly.

### BRIEF DESCRIPTION OF SEVERAL VIEWS OF THE DRAWINGS

Other advantages will become apparent from the following description of the drawings. The drawings show one embodiment of the present invention only for illustrative purposes. The drawings, the specification and the claims include a number of features in combination. For reasons of expediency the person skilled in the art will also consider the features individually and combine them into other meaningful combinations.

FIG. 1 is an isometric view of an inventive stator comprising a stator assembly and a winding support device.

FIG. 2 is a front view of a stator according to the invention.

FIG. 3 is a sectional view of an inventive stator along the section line A-A in FIG. 2.

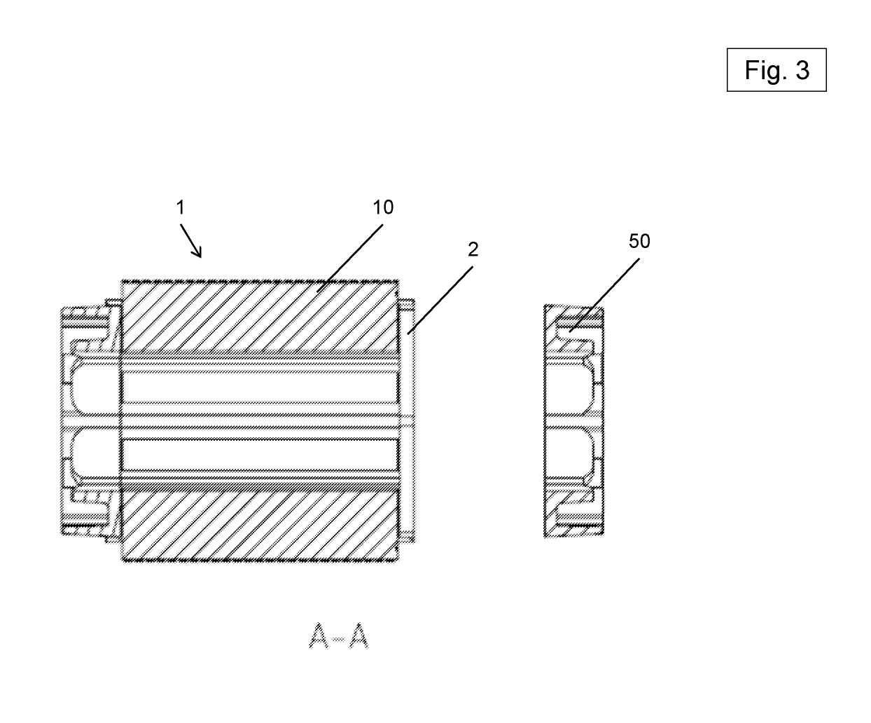

FIG. 4 is an isometric view of an end face of a stator assembly comprising a first part of a first embodiment of a connecting device between the stator assembly and a winding support device.

FIG. 5 is an isometric view of an end face of a stator assembly comprising a first part of a second embodiment of a connecting device between the stator assembly and a winding support device.

FIG. 6 is an isometric view of an end face of a stator assembly comprising a first part of a third embodiment of a connecting device between the stator assembly and a winding support device.

FIG. 7 is an isometric view of an end face of a stator assembly comprising a first part of a fourth embodiment of a connecting device between the stator assembly and a winding support device.

FIG. 8 is a front view of an end face of a stator assembly comprising a first part of a fourth embodiment of a connecting device between the stator assembly and a winding support device.

FIG. 9 is a sectional view of a stator assembly along the section line A-A in FIG. 8.

FIG. 10 is an isometric view of an end face of a first embodiment of a receiving device.

FIG. 11 is an isometric view of an end face of a second embodiment of a receiving device.

FIG. 12 is a front view of a second embodiment of a receiving device.

FIG. 13 is a sectional view of a stator assembly along the section line A-A in FIG. 12.

FIG. 14 is an isometric view of an end face of a third embodiment of a receiving device.

FIG. 15 is an isometric view of an end face of a fourth embodiment of a receiving device.

FIG. 16 is a front view of a third embodiment of a receiving device.

FIG. 17 is a sectional view of a stator assembly along the section line A-A in FIG. 16.

### DETAILED DESCRIPTION

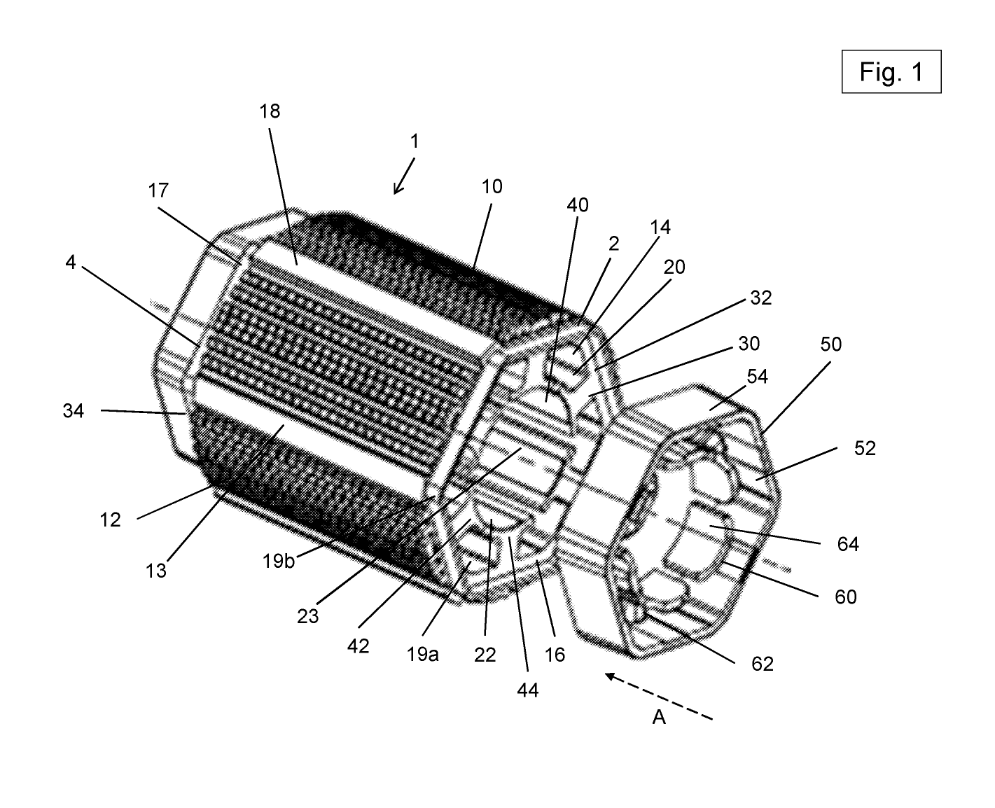

FIG. 1 shows an inventive stator 1 for an electrodynamic machine. The electrodynamic machine may be, for example, an electric motor. The stator 1 comprises, in particular, a stator assembly 10 and a winding support device 50. The stator has a first end face 2 and a second end face 4.

The stator assembly 10 consists of a plurality of individual sheet metal rings 12, which are securely connected to each other, so that the stator 1 and the stator assembly 10 exhibit a more or less cylindrical shape. Furthermore, the stator assembly 10 has an outside 13, an inside 14 as well as a first end face 16 and a second end face 17.

The individual sheet metal rings 12 exhibit a hexagonal shape, where in this case the respective corners 18 on the inside 19a and outside 19b of the sheet metal ring 12 are rounded off.

In addition, the sheet metal rings 12 comprise six web elements 20, which are arranged in a uniformly distributed manner on the inside 19a of the sheet metal rings 12 and extend radially relative to the interior of the sheet metal ring 12. When the individual sheet metal rings 12 are connected to the stator assembly 10, the individual web elements 20 form together six continuous webs 22, which extend along the inner surface of the stator assembly 10 over the entire length of the stator assembly 10.

The hexagonal shape of the sheet metal rings 12 gives the stator assembly 10 the shape of a cylindrical hexagonal tube with a central passage opening 23. The sheet metal rings 12 are made of a metal. However, it is also possible to make the sheet metal rings 12 of any other suitable material.

On the inner surface of the stator assembly 10, there is a web insulation 30, which is used to insulate the inner surface of the stator assembly 10.

The web insulation 30 is also in the shape of a cylindrical hexagonal tube having a first end 32, a second end 34. The web insulation has six uniformly distributed winding support elements 40, which extend radially relative to the interior of the stator assembly 10. The winding support elements 40 enclose the webs 22 of the stator assembly 10; and each of these winding support elements has an elongated base body 42 with a carrier plate 44. A wire (not shown) (for example, copper wire or any other suitable material) is wound around each winding support element 40 to form a stator coil. In this case the wire (not shown) is wound several times around the elongated base body 42 and below the carrier plate 44 of the winding support element 40. The web insulation 30 is made of a synthetic plastic material, which can be attached to the stator assembly 10 by means of an injection molding process. However, it is also possible that the web insulation 30 is made of any other suitable material or mixture of materials. Moreover, it is also possible that any other suitable method for attaching the web insulation 30 to the stator assembly 10 can be used. Furthermore, it is also possible that the web insulation 30 is produced as a prefabricated part in a separate process, in order to be attached, as a part or as a part consisting of several components, to the stator assembly 10.

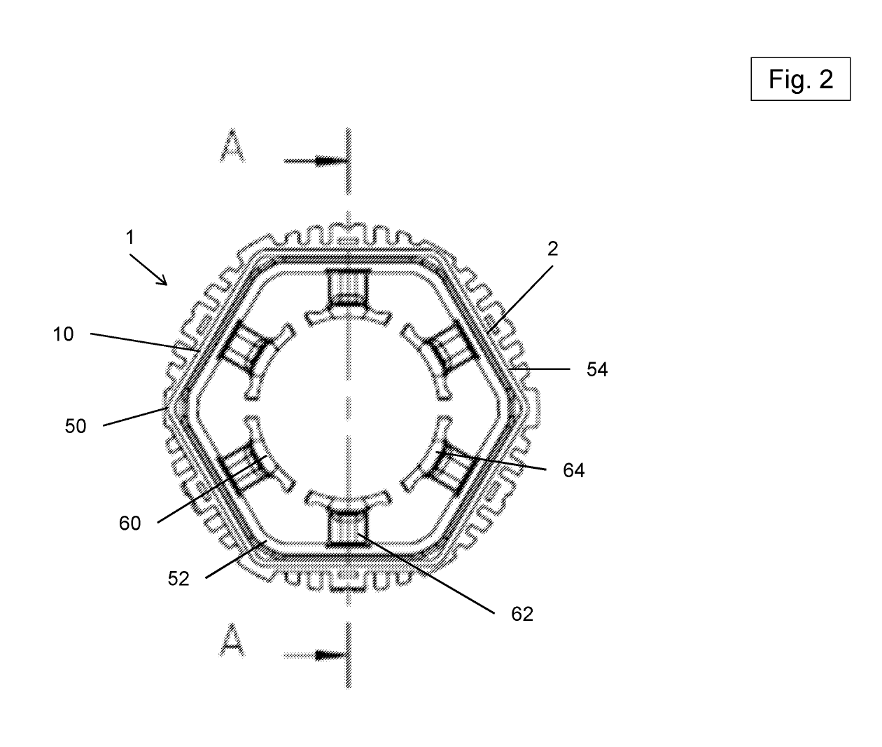

As shown in FIG. 1 and FIG. 2, the winding support device 50 is designed as a hexagonal ring element having an inside 52 and an outside 54. The respective corners 55 on the inside 52 and the outside 54 of the winding support device 50 are rounded off in conformity with the stator assembly 10. On the inside 52 of the winding support device 50 there are six uniformly distributed winding support ends 60 in conformity with the stator assembly 10. Each of the winding support ends 60 has, in conformity with the winding support elements 40, an elongated base body 62 with a carrier plate 64. However, it is also possible that the winding support device 50 consists of a plurality of components that are assembled in a separate process to form the hexagonal ring element. The winding support device 50 is made of a plastic material having an especially high mechanical strength. However, it is also possible to use any other suitable material having a high mechanical strength.

The winding support device 50 is positioned and secured in the direction A on the first end face 16 of the stator assembly 10. At the same time the winding support device 50 is positioned on the stator assembly 10 in such a way that the winding support ends 60 of the winding support device 50 are aligned in extension to the winding support elements 40 of the stator assembly 10.

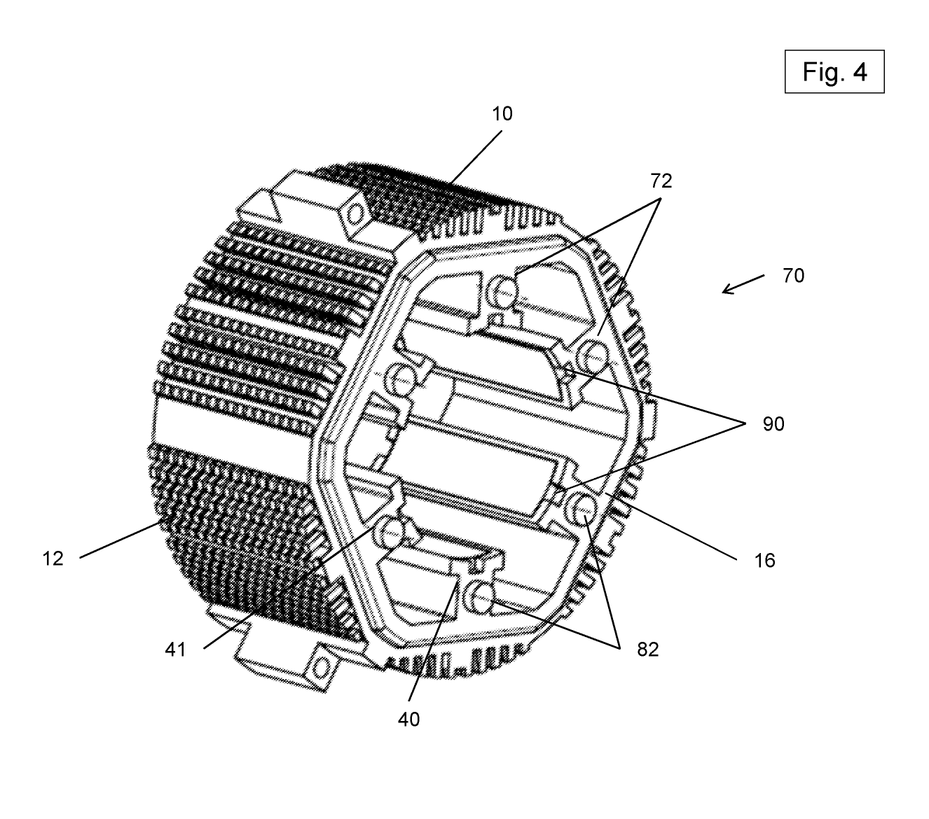

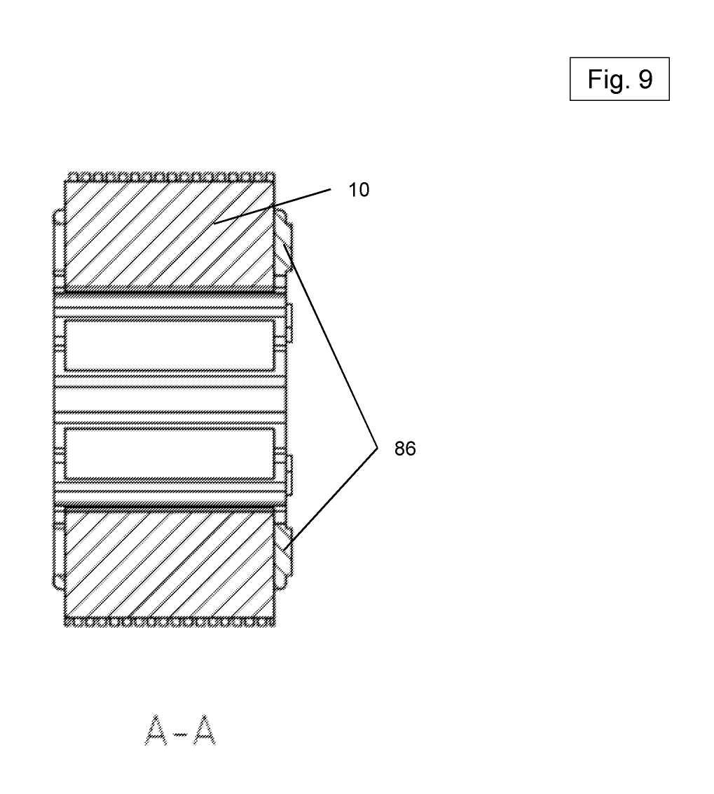

In order to mount the winding support device 50 on the first end face 16 or the second end face 17 of the stator assembly 10, a connecting device 70 is provided (see FIGS. 4, 5, 6, 7, 8, 9). For this purpose the connecting device 70 comprises a first connecting element 72 and a second connecting element (not shown). In addition, the first connecting element 72 is located on the stator assembly 10; and the second connecting element is located on the winding support device 50.

According to a first embodiment, the connecting device 70 is implemented by means of a first plug-in connection. For this purpose the stator assembly 10 has, as shown in FIG. 4, six pins 82 on the first end face 16. Each pin 82 is positioned on the end face 41 of each winding support element 40. On the outer surface (not shown) of the winding support device 50, which is directed towards the first end face 16 of the stator assembly 10, there are six uniformly distributed bores (not shown). The bores are configured in such a way that the pins 82 can be received in these bores, so that it is possible to position and hold the winding support device 50 on the first end face 16 of the stator assembly 10. Moreover, the winding support elements 40 are provided with six recesses 90. One recess 90 may be found in each case at the upper end of the end face 41 of the winding support element 40. Six insertion elements (not shown) are positioned at equal distances from one another on the outer surface (not shown) of the winding support device 50, which is directed towards the first end face 16 of the stator assembly 10. The insertion elements serve the purpose of being inserted into the recesses 90, so that the winding support device 50 can also be positioned and held on the first end face 16 of the stator assembly 10.

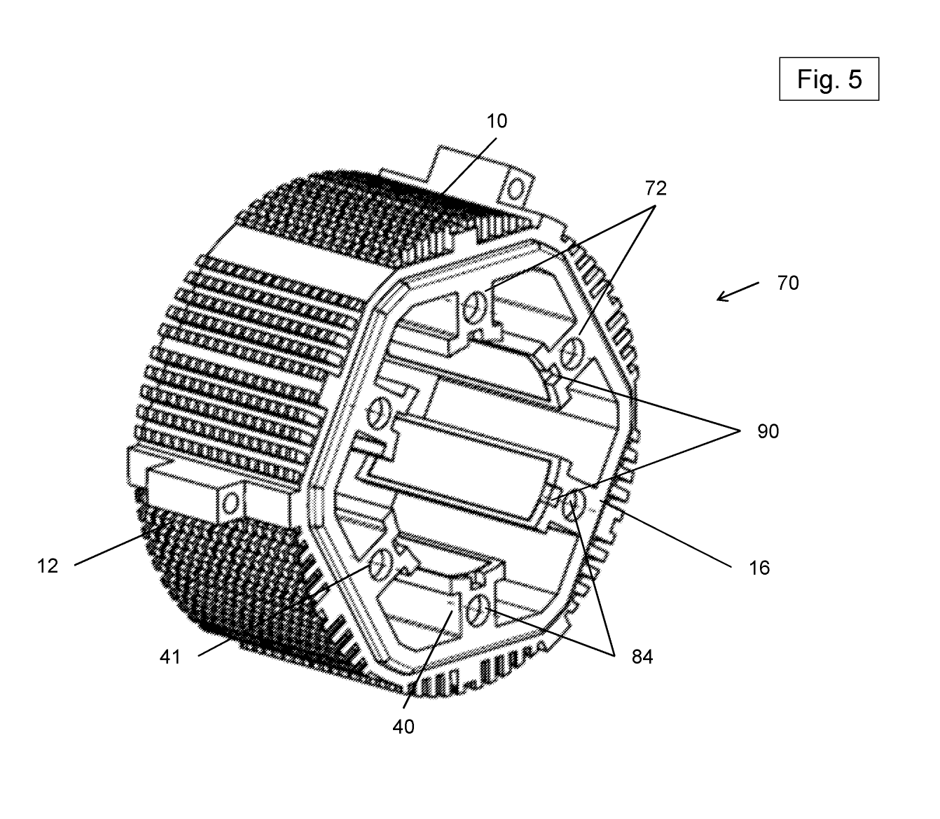

As shown in FIG. 5, the connecting device 70 between the stator assembly 10 and the winding support device 50 is implemented, according to a second embodiment, by means of a second plug-in connection. For this purpose the first end face 16 of the stator assembly 10 is provided with six bores 84. One bore each 84 is located on the end face 41 of each winding support element 40. On the outer surface (not shown) of the winding support device 50, which is directed towards the first end face 16 of the stator assembly 10, there are six uniformly distributed pins (not shown). The pins are configured in such a way that the bores 84 can receive the pins, so that it is possible to position and hold the winding support device 50 on the first end face 16 of the stator assembly 10. Moreover, the winding support elements 40 are provided with six recesses 90. One recess 90 may be found in each case at the upper end of the end face of the winding support element 40. Six insertion elements (not shown) are positioned at equal distances from one another on the outer surface (not shown) of the winding support device 50, which is directed towards the first end face 16 of the stator assembly 10. The insertion elements serve the purpose of being inserted into the recesses 90, so that the winding support device 50 can also be positioned and held on the first end face 16 of the stator assembly 10.

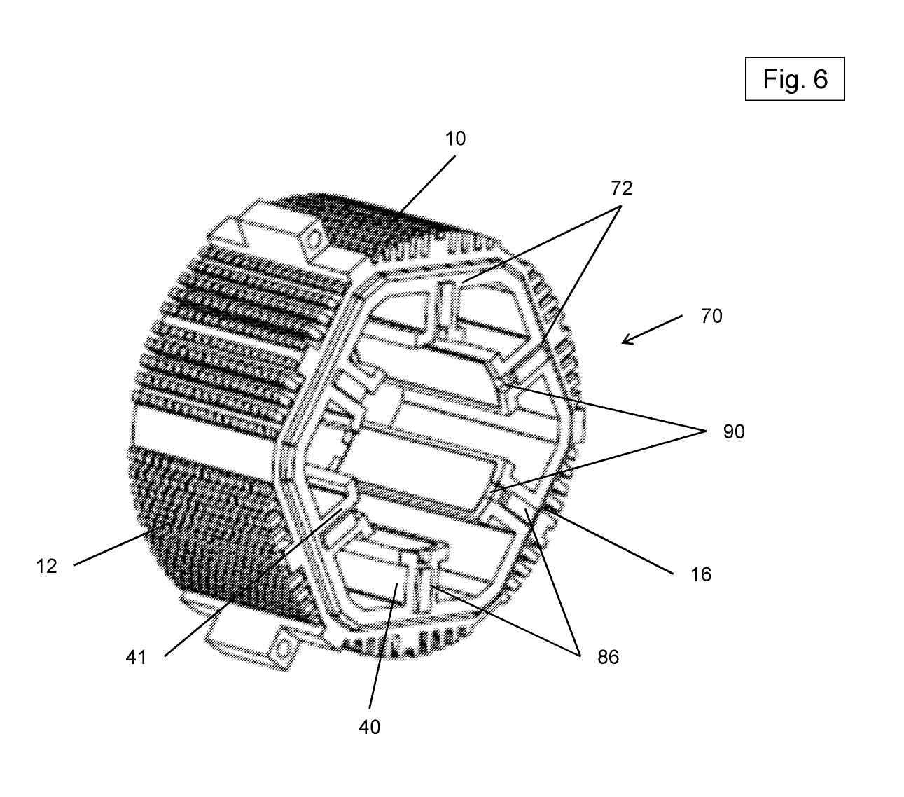

According to a third embodiment, the connecting device 70 between the stator assembly 10 and the winding support device 50 can be implemented by means of a third plug-in connection. For this purpose FIG. 6 shows that the first end face 16 of the stator assembly 10 is provided with six rectangular elevations 86. One rectangular elevation each 86 is located on the end face 41 of each winding support element 40. On the outer surface (not shown) of the winding support device 50, which is directed towards the first end face 16 of the stator assembly 10, there are six uniformly distributed rectangular recesses (not shown). The rectangular recesses are configured in such a way that the elevations 86 can be inserted into the recesses, so that it is possible to position and hold the winding support device 50 on the first end face 16 of the stator assembly 10. Moreover, the winding support elements 40 in turn are provided with six recesses 90. One recess 90 may be found in each case at the upper end of the end face of the winding support element 40. Six insertion elements are positioned at equal distances from one another on the outer surface (not shown) of the winding support device 50, which is directed towards the first end face 16 of the stator assembly 10. The insertion elements serve the purpose of being inserted into the recesses 90, so that the winding support device 50 can also be positioned and held on the first end face 16 of the stator assembly 10.

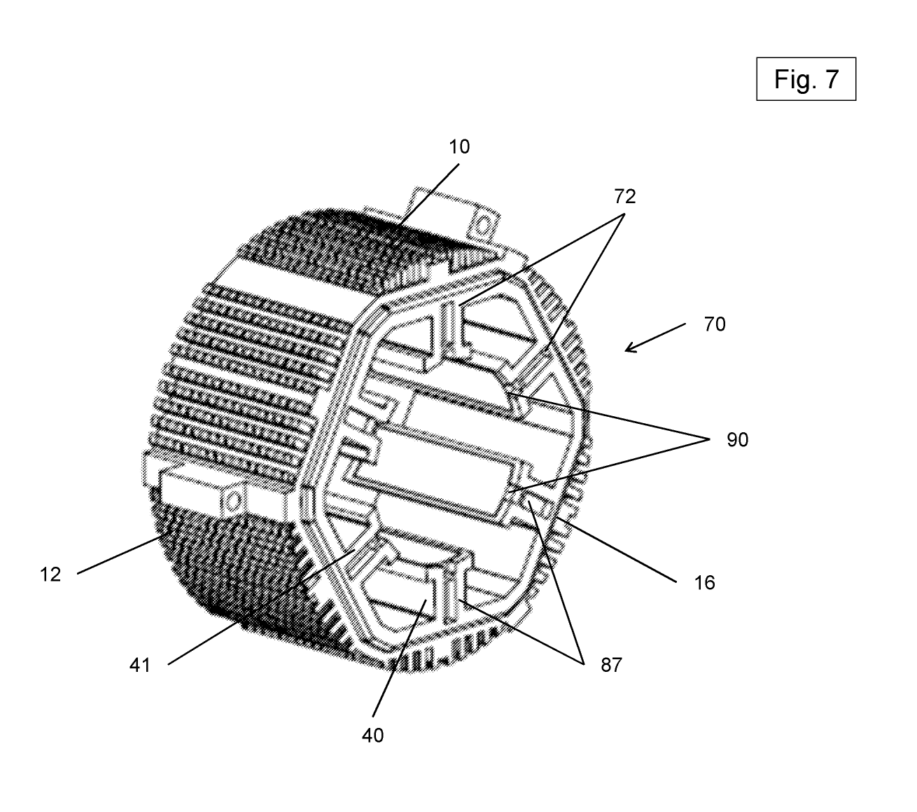

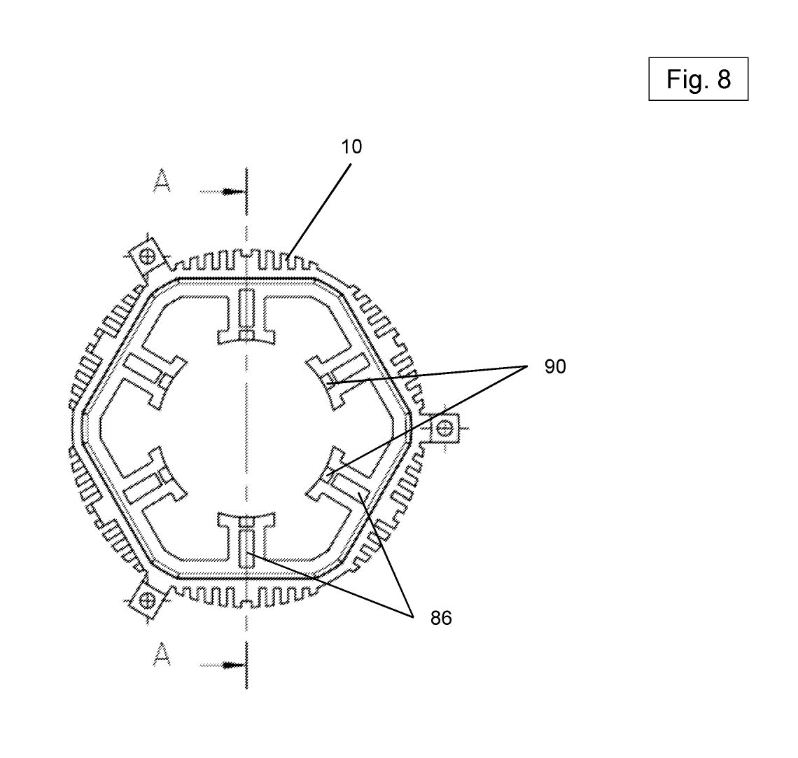

According to a fourth embodiment, the connecting device 70 between the stator assembly 10 and the winding support device 50 can be implemented by means of a fourth plug-in connection. For this purpose FIGS. 7 and 8 show that the first end face 16 of the stator assembly 10 is provided with six rectangular recesses 87. One rectangular recess each 87 is located on the end face 41 of each winding support element 40. On the outer surface (not shown) of the winding support device 50, which is directed towards the first end face 16 of the stator assembly 10, there are six uniformly distributed rectangular elevations (not shown). The rectangular elevations are configured in such a way that the elevations can be inserted into the recesses 87, so that it is possible to position and hold the winding support device 50 on the first end face 16 of the stator assembly 10. Moreover, the winding support elements 40 in turn are provided with six recesses 90. One recess 90 may be found in each case at the upper end of the end face of the winding support element 40. Six insertion elements are positioned at equal distances from one another on the outer surface (not shown) of the winding support device 50, which is directed towards the first end face 16 of the stator assembly 10. The insertion elements serve the purpose of being inserted into the recesses 90, so that the winding support device 50 can also be positioned and held on the first end face 16 of the stator assembly 10.

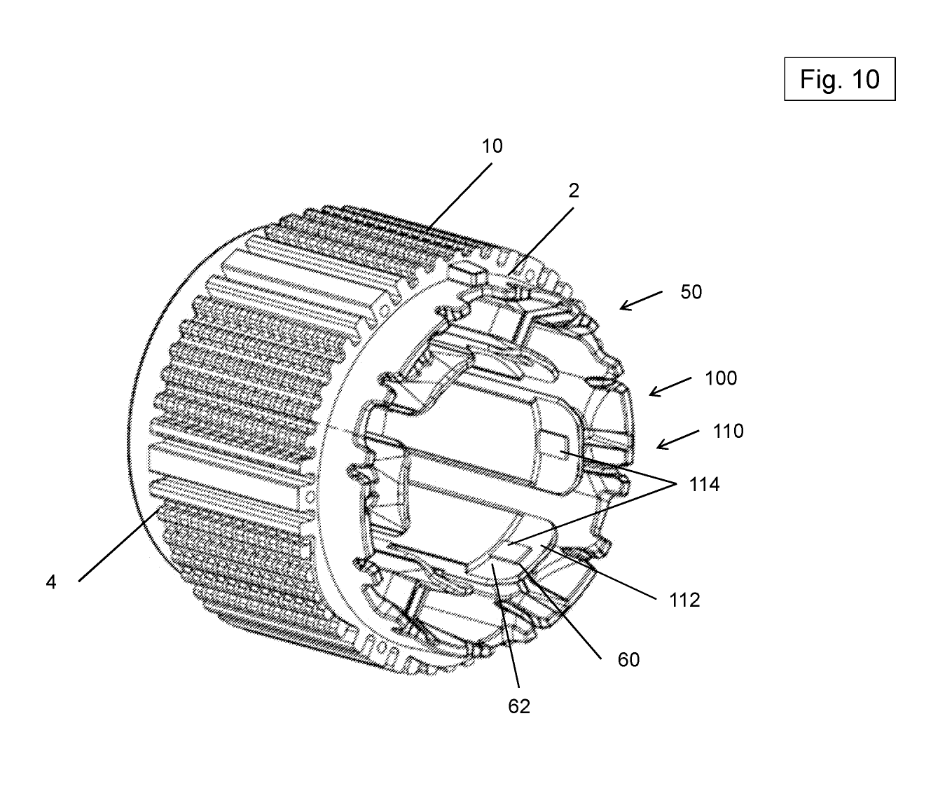

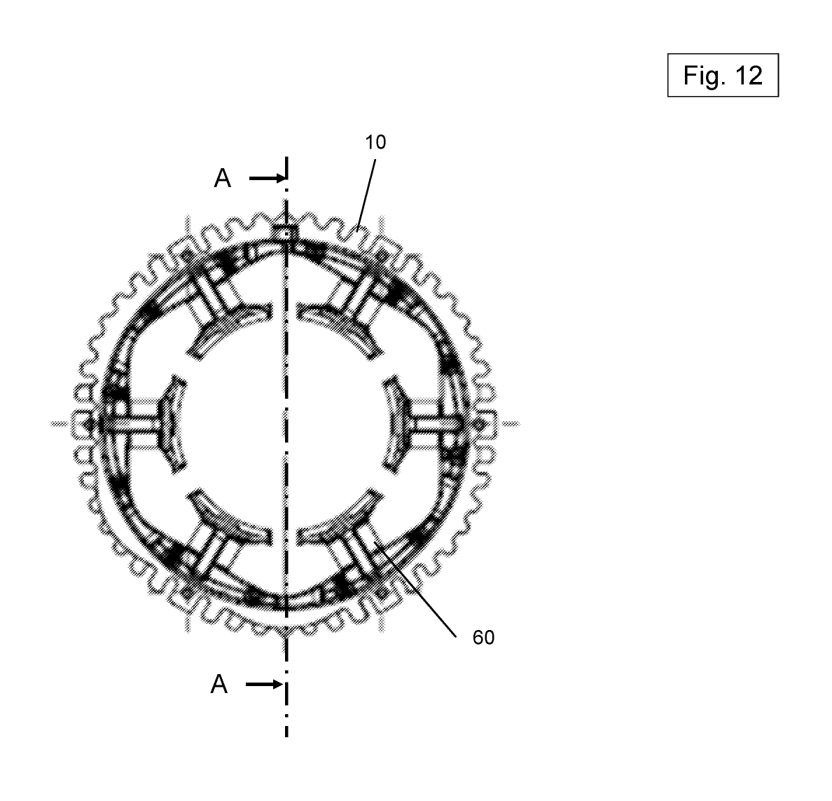

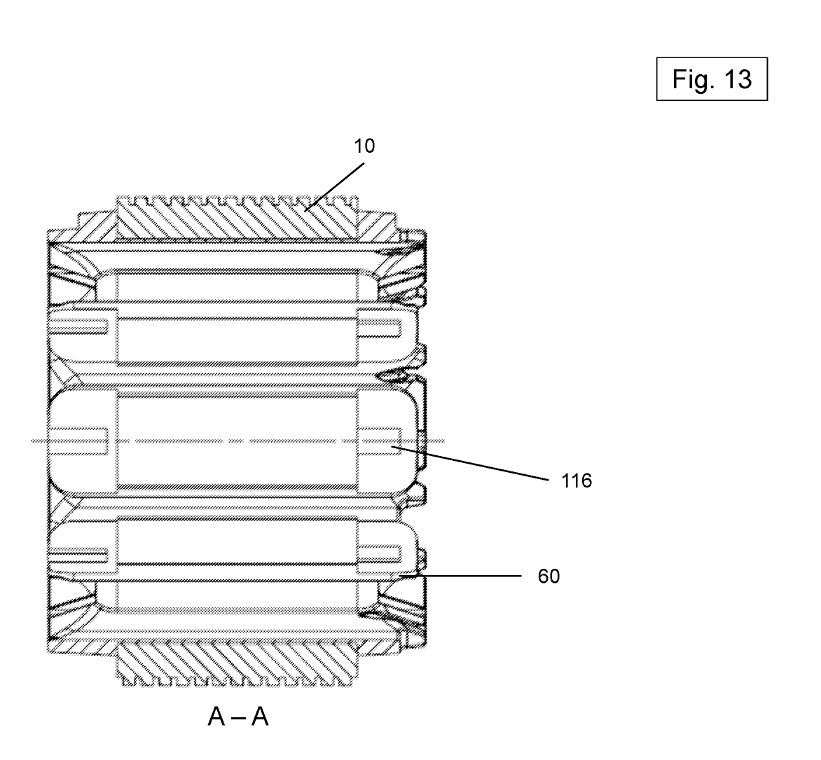

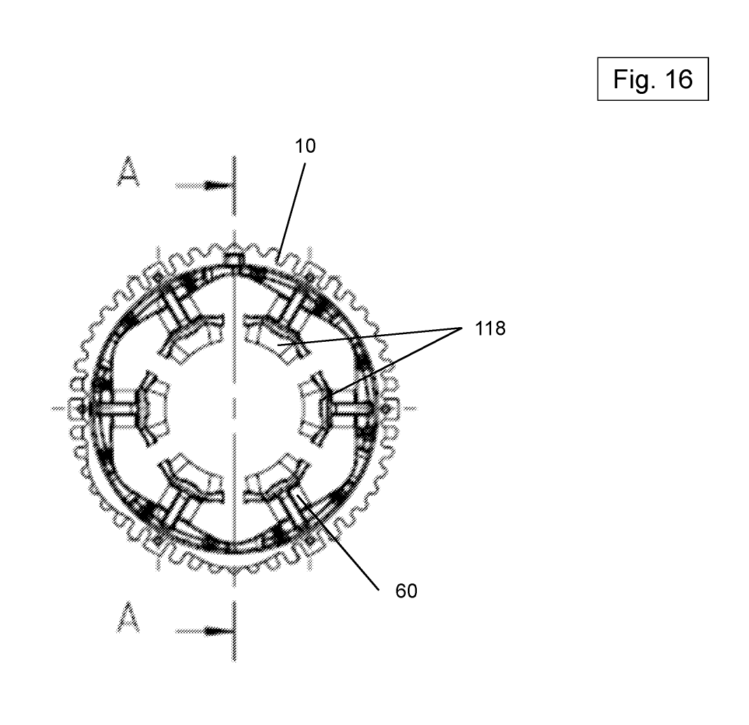

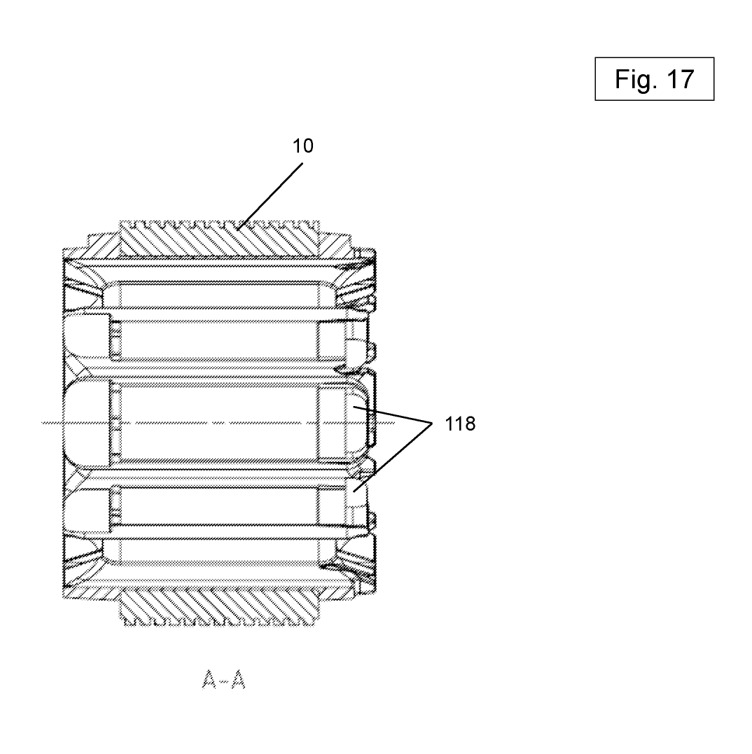

As can be seen in FIGS. 10 to 17, the winding support device 50 comprises a receiving device 100 for receiving an additional add-on part (not shown) on the stator 1. The add-on part can be, for example, a receptacle for a rotor (not shown) or a transmission mounting (not shown).

A first embodiment of the receiving device 100 is shown in FIG. 10. In this case the receiving device 100 comprises a first part 110 and a second part (not shown). According to the first embodiment, the first part 110 of the receiving device 100 is located on the winding support device 50, which is attached to the first end face 2 of the stator 1. The receiving device 100 consists of a lowered plane 112 on the carrier plates 62 of the winding support ends 60 and, in addition, a rectangular elevation 114, which may be found on the lowered plane 112.

According to the first embodiment, the second part (not shown) of the receiving device 100 is located on the add-on part (not shown) and consists of a counter-piece, which corresponds to the first part and which has a raised plane for resting against the lowered plane 112 of the first part 110, and a rectangular recess for receiving the rectangular elevation 114 of the first part 110. This plug-in connection makes it possible to position and hold the add on part (not shown) on the stator 1.

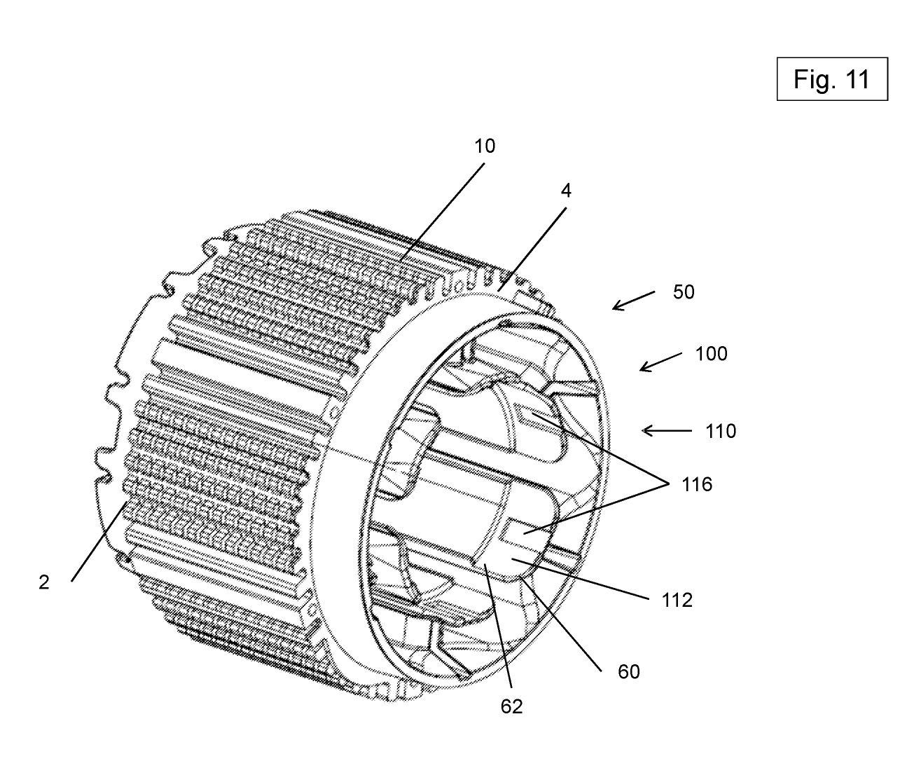

A second embodiment of the receiving device 100 is shown in FIGS. 11, 12, and 13. In this case the receiving device 100 in turn comprises a first part 110 and a second part (not shown). According to the second embodiment, the first part 110 of the receiving device 100 is located on the winding support device 50, which is attached to the second end face 4 of the stator 1. The receiving device 100 consists of a lowered plane 112 on the carrier plates 62 of the winding support ends 60 and, in addition, a rectangular depression 116, which may be found on the lowered plane 112.

According to the second embodiment, the second part (not shown) of the receiving device 100 is located on the add-on part (not shown) and consists of a counter-piece, which matches the first part 110 and which has a raised plane for resting against the lowered plane 112 of the first part 110, and a rectangular elevation for insertion into the rectangular depression 116 of the first part 110. This plug-in connection makes it possible once again to position and to hold the add on part (not shown) on the stator 1.

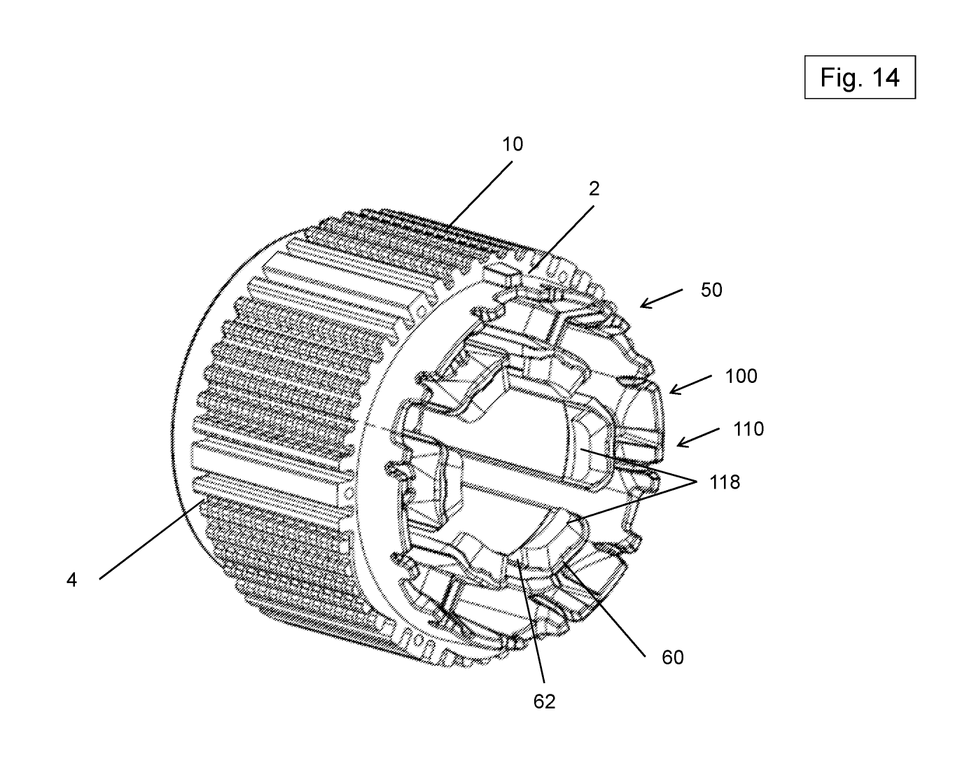

A third embodiment of the receiving device 100 is shown in FIG. 14. In this case the receiving device 100 comprises once again a first part 110 and a second part (not shown). According to the first embodiment, the first part 110 of the receiving device 100 is located on the winding support device 50, which is attached to the first end face 2 of the stator 1. The receiving device 100 consists of a conically tapering elevation 118 on the carrier plates 62 of the winding support ends 60.

According to the third embodiment, the second part (not shown) of the receiving device 100 is located on the add-on part (not shown) and consists of a counter-piece, which corresponds to the first part 110 and which is positioned on the add-on part (not shown). The counter-piece consists of a corresponding depression, into which the first part 110 of the receiving device 100 is inserted. This plug-in connection makes it possible once again to position and to hold the add on part (not shown) on the stator 1.

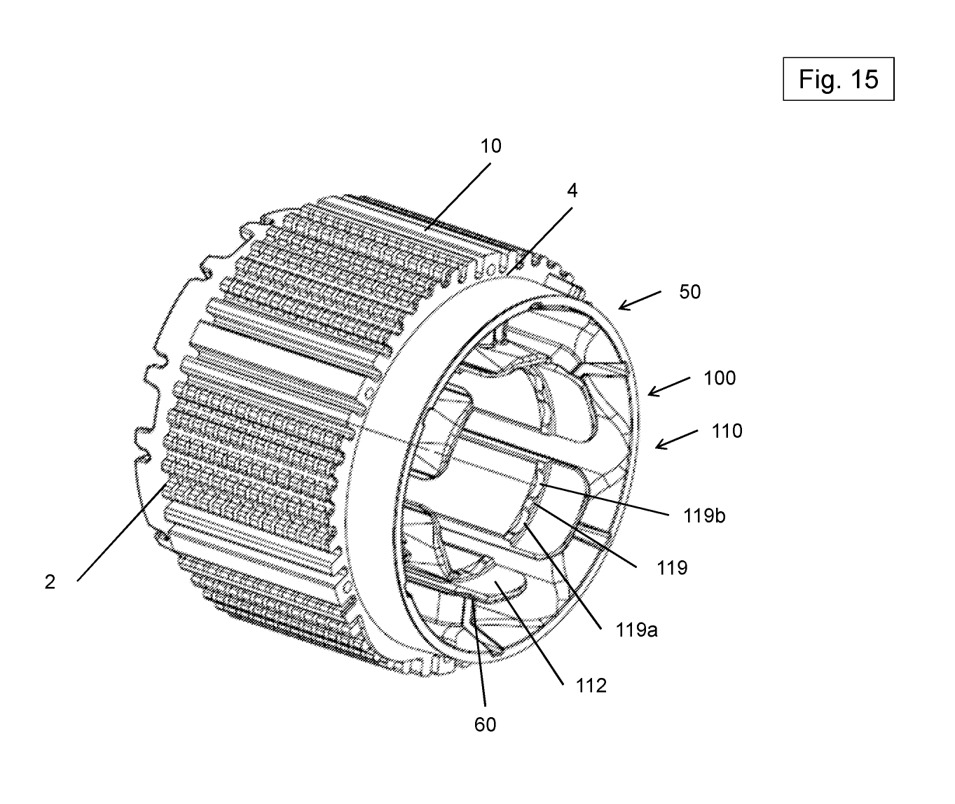

A fourth embodiment of the receiving device 100 is shown in FIG. 15. In this case the receiving device 100 comprises once again a first part 110 and a second part (not shown). According to the fourth embodiment, the first part 110 of the receiving device 100 is located on the winding support device 50, which is attached to the second end face 2 of the stator 1. The receiving device 100 consists of an elongated elevation 119 with two semi-round recesses 119a, 119b, which are positioned adjacent to each other, on each carrier plate 62 of the winding support ends 60.

According to the fourth embodiment, the second part (not shown) of the receiving device 100 consists of a counter-piece, which corresponds to the first part 110 and which is positioned on the add-on part (not shown). In order to connect the winding support device 50 to the stator assembly 10, the first part 110 is brought into engagement with the second part of the add on part.

By attaching the winding support device 50 on the stator assembly 10, the stator 1 has a web insulation 30 made of a good thermally conductive material as well as a winding support device 50 of a higher strength material. As a result, the stator 1 meets the requirements of the winding process, in particular the high wire tension, and simultaneously ensures an optimized dissipation of the heat from the stator 1.

1. A stator for an electrodynamic machine comprising:
a stator assembly with a first end face and a second end face,
wherein a thermally conductive web insulation is provided on the inside of the stator assembly; and a winding support device is provided on at least one of the end faces of the stator assembly.

2. The stator of claim 1 wherein the winding support device is designed as an annular part.

3. The stator of claim 2 wherein the annular part consists of at least two components.

4. The stator of claim 1 wherein a connecting device is provided between the thermally conductive web insulation and the winding support device.

5. The stator of claim 4 wherein the connecting device comprises a first connecting element and a second connecting element.

6. The stator of claim 5 wherein the first connecting element is positioned on the thermally conductive web insulation; and that the second connecting element is positioned on the winding support device.

7. The stator of claim 1 wherein the winding support device includes at least one higher strength material.

8. The stator of claim 7 wherein the higher strength material is implemented by means of a plastic material.

9. The stator of claim 1 wherein the thermally conductive web insulation is implemented by means of a plastic material.

10. The stator of claim 1 wherein the winding support device comprises at least one receiving device for receiving an add-on part.

11. The stator of claim 10 wherein the receiving device is a lowered function surface.

12. The stator of claim 10 wherein the receiving device is a raised function surface.

13. The stator of claim 4 wherein the connecting device is a plug-in connection, screw connection or tongue and groove connection.

14. A method of producing a stator for an electrodynamic machine comprising:
providing a stator assembly with a first end face and a second end face;
providing a thermally conductive web insulation on the inside of the stator assembly; and
providing a winding support device on at least one of the end faces of the stator assembly.

15. The method of claim 14 wherein the stator is molded with the material of the thermally conductive web insulation.

16. The method of claim 14 wherein the stator is encapsulated with the material of the thermally conductive web insulation.
